(19) United States
(12) Patent Application Publication
(10) Pub. No.: US 2024/0168409 A1
(43) Pub. Date: May 23, 2024

(54) DEVELOPING DEVICE AND IMAGE FORMING APPARATUS

(71) Applicant: FUJIFILM Business Innovation Corp., Tokyo (JP)

(72) Inventor: Kenta URAYAMA, Kanagawa (JP)

(73) Assignee: FUJIFILM Business Innovation Corp., Tokyo (JP)

(21) Appl. No.: 18/321,331

(22) Filed: May 22, 2023

(30) Foreign Application Priority Data
Nov. 17, 2022 (JP) 2022-184286

(51) Int. Cl. G03G 15/08

(52) U.S. Cl. CPC G03G 15/0898

(57) ABSTRACT

A developing device includes: a development roller that has a circumferential surface on which a developer layer is formed at a portion facing an image carrier; a first seal portion that covers an outer side, in a radial direction, of an axial end portion of the development roller where the developer layer is not formed at the portion facing the image carrier; and a second seal portion that extends inward in an axial direction from the first seal portion, and that covers an outer side, in the radial direction, of an axial end portion of the developer layer.

### CROSS-REFERENCE TO RELATED APPLICATIONS

This application is based on and claims priority under 35 USC 119 from Japanese Patent Application No. 2022-184286 filed Nov. 17, 2022.

### BACKGROUND

### (i) Technical Field

The present disclosure relates to a developing device and an image forming apparatus.

### (ii) Related Art

Japanese Unexamined Patent Application Publication No. 2010-145570 discloses a technology relating to a developing device and an image forming apparatus including the developing device. In this technology, the developing device includes a housing including a developer container and a rectangular opening, a hollow cylindrical developer transporter that rotates inside the housing while passing the opening to hold a developer on its outer circumferential surface to transport the developer to a development area, and a flexible planar member. The flexible planar member has a first end portion located upstream in the rotation direction of the developer transporter fixed at the opening in the housing at a downstream edge located downstream in the rotation direction of the developer transporter, and a second end portion located downstream in the rotation direction of the developer transporter. The second end portion serves as a free end portion. The second end portion comes into contact with a developer layer held on at least a portion of an outer circumferential surface serving as a developer holding area in a rotation axial direction of the developer transporter that has passed a downstream edge of the opening.

Japanese Unexamined Patent Application Publication No. 2006-201591 discloses a technology relating to a process unit and an image forming apparatus including the process unit. The process unit develops an electrostatic latent image formed on a latent image carrier included in a copying machine, a printer, or a fax machine serving as an image forming apparatus into a visible image. In this technology, the process unit includes an image carrier, a development member that is disposed to face the image carrier and that supplies a developer to the image carrier to form a visible image, seal members disposed near both end portions of the development member while being in contact with the surface of the development member to prevent leakage of the developer, and a cleaning member that comes into contact with the surface of the image carrier to remove the developer on the image carrier. The cleaning member comes into contact with an area of the image carrier that faces the surface of the development member that is in contact with at least the seal members.

### SUMMARY

Aspects of non-limiting embodiments of the present disclosure relate to reduction of toner scatter from the end portion of a developer layer in an axial direction on a development roller compared to a structure simply including a first seal portion.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device that includes: a development roller that has a circumferential surface on which a developer layer is formed at a portion facing an image carrier; a first seal portion that covers an outer side, in a radial direction, of an axial end portion of the development roller where the developer layer is not formed at the portion facing the image carrier; and a second seal portion that extends inward in an axial direction from the first seal portion, and that covers an outer side, in the radial direction, of an axial end portion of the developer layer.

### BRIEF DESCRIPTION OF THE DRAWINGS

Exemplary embodiments of the present disclosure will be described in detail based on the following figures, wherein:

FIG. 1 is a schematic diagram of an image forming apparatus of the present exemplary embodiment;

FIG. 2 is a cross-sectional perspective view of a developing device of the image forming apparatus;

FIG. 3 is a cross-sectional view of a front-side portion of the developing device and a photoconductor drum;

FIG. 4 is a perspective view of a first-side portion, in the axial direction, of the front-side portion of the developing device;

FIG. 5 is a front view of the first-side portion, in the axial direction, of the front-side portion of the developing device; and

FIG. 6 is a front view of a seal member.

### DETAILED DESCRIPTION

Exemplary embodiments according to the present disclosure are described below in detail with reference to the drawings. The drawings are schematic or simplified.

Two directions in the horizontal direction that are perpendicular to each other are defined as an X direction and a Y direction, and indicated with arrow X and arrow Y. The vertical direction perpendicular to the X direction and the Y direction is defined as a Z direction, and indicated with arrow Z. The axial direction of a development roller 70 and a photoconductor drum 22 according to the present exemplary embodiment described below is the Y direction.

Image Forming Apparatus

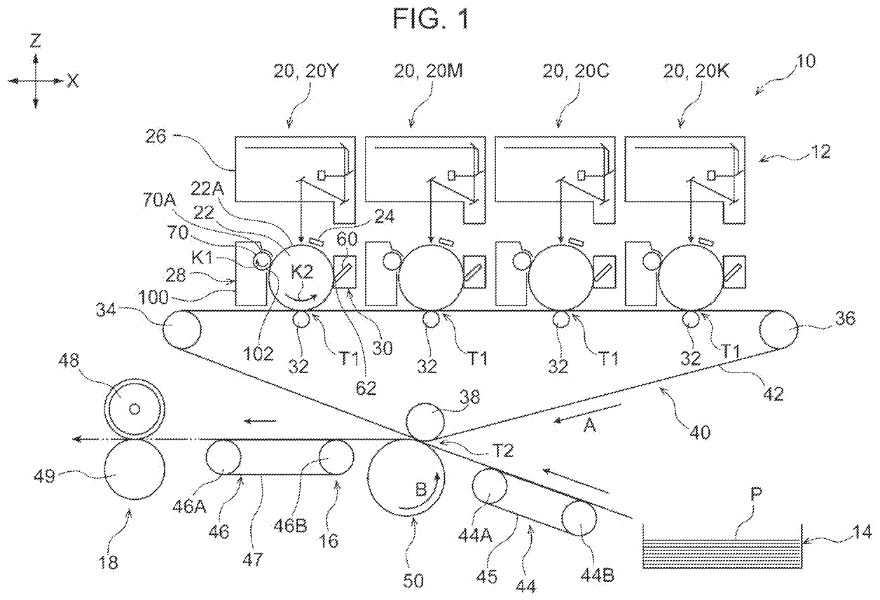

As illustrated in FIG. 1, an image forming apparatus 10 is an electrophotographic system that forms a toner image on a recording sheet P having a sheet shape and serving as a recording medium. The image forming apparatus 10 includes, in an apparatus body (not illustrated), an image forming unit 12, a container 14, a transporting unit 16, and a fixing device 18.

Image Forming Unit

As illustrated in FIG. 1, the image forming unit 12 included in the image forming apparatus 10 has a function of forming a toner image on a recording sheet P. More specifically, the image forming unit 12 includes toner image forming portions 20 and an intermediate transfer device 40.

Toner Image Forming Portions

The toner image forming portions 20 form toner images of different colors. In the present exemplary embodiment, the toner image forming portions 20 include toner image forming portions 20Y, 20M, 20C, and 20K for four colors of yellow (Y), magenta (M), cyan (C), and black (K).

In the following description, when the color distinguishment between yellow (Y), magenta (M), cyan (C), and black (K) is to be described, any of the letters Y, M, C, and K is appended to the reference sign of the corresponding component. When the color distinguishment is not to be described, the letters Y, M, C, and K may be omitted. The toner image forming portions 20 for the different colors have the same structure. Thus, components of the yellow toner image forming portion 20Y are simply denoted with the reference signs in FIG. 1.

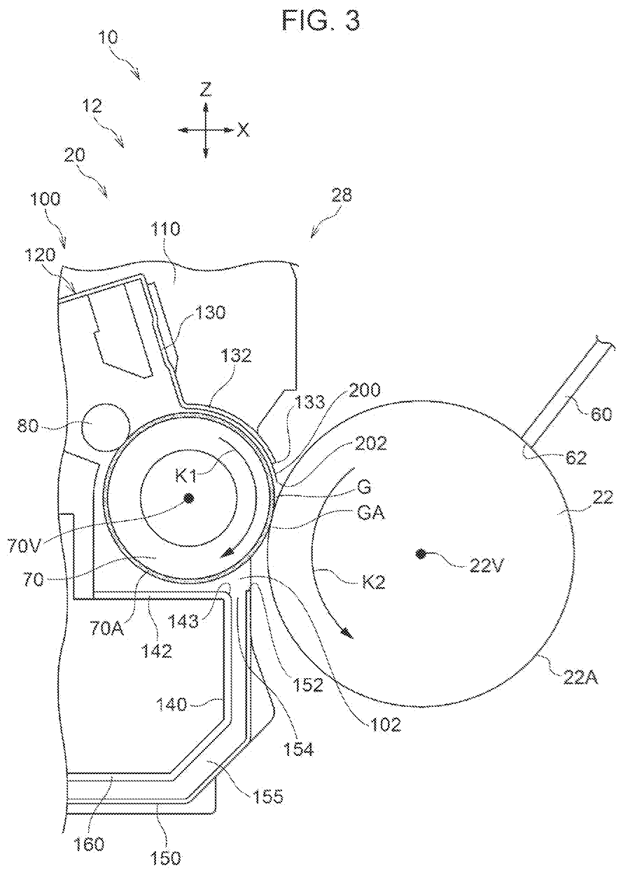

The toner image forming portion 20 for each color includes the photoconductor drum 22 that rotates in a K2 direction, or counterclockwise in FIG. 1. The photoconductor drum 22 is an example of an image holder. The toner image forming portion 20 for each color includes a charging device 24, an exposure device 26, a developing device 28, and a cleaning device 30 sequentially from the upstream side in the rotation direction of the photoconductor drum 22. The developing device 28 includes the development roller 70 that rotates in a K1 direction or clockwise in FIG. 1 (also refer to FIG. 3). The details of the developing device 28 are described below. The cleaning device 30 includes a cleaning blade 60 serving as an example of a cleaning member.

In the toner image forming portion 20 for each color, the charging device 24 electrically charges an outer circumferential surface 22A of the photoconductor drum 22. The exposure device 26 exposes the outer circumferential surface 22A of the photoconductor drum 22 electrically charged by the charging device 24 to light to form an electrostatic latent image on the outer circumferential surface 22A of the photoconductor drum 22. The developing device 28 develops the electrostatic latent image formed by the exposure device 26 on the outer circumferential surface 22A of the photoconductor drum 22 to form a toner image. The cleaning blade 60 (also refer to FIG. 3) having a far end portion 62 in contact with the outer circumferential surface 22A of the photoconductor drum 22 removes toner left on the outer circumferential surface 22A of the photoconductor drum 22 after the toner images are transferred to an intermediate transfer belt 42 described below.

Intermediate Transfer Device

The intermediate transfer device 40 serving as an example of a transfer unit includes first transfer rollers 32, the intermediate transfer belt 42 serving as an example of an intermediate transfer body, and a second transfer roller 50. More specifically, the intermediate transfer device 40 first-transfers toner images formed on the outer circumferential surfaces 22A of the photoconductor drums 22 for the respective colors to the intermediate transfer belt 42 in a superposed manner, and second-transfers the superposed toner images to a recording sheet P with the second transfer roller 50.

First Transfer Rollers

Each first transfer roller 32 transfers a toner image formed on the outer circumferential surface 22A of the photoconductor drum 22 of the corresponding color to the outer circumferential surface of the intermediate transfer belt 42 at a first transfer position T1 between the photoconductor drum 22 and the first transfer roller 32. In the present exemplary embodiment, when a first transfer voltage is applied across each first transfer roller 32 and the corresponding photoconductor drum 22, the toner image formed on the outer circumferential surface of the photoconductor drum 22 is transferred to the outer circumferential surface of the intermediate transfer belt 42 at the first transfer position T1.

Intermediate Transfer Belt

The intermediate transfer belt 42 has an outer circumferential surface to which toner images are transferred. The intermediate transfer belt 42 has a loop shape, and is wound around a driving roller 34, a tension roller 36, and a back-up roller 38 to have its position fixed. The driving roller 34 is driven to rotate by a driving portion not illustrated to cycle the intermediate transfer belt 42 in the direction of arrow A at a predetermined rate.

The back-up roller 38 is disposed to face the second transfer roller 50 with the intermediate transfer belt 42 interposed therebetween. A portion where the second transfer roller 50 and the intermediate transfer belt 42 are in contact and where the second transfer roller 50 and the intermediate transfer belt 42 hold the recording sheet P therebetween is a second transfer position T2 at which the toner images are transferred to the recording sheet P from the intermediate transfer belt 42.

Transporting Unit

The transporting unit 16 includes a first transporting unit 44 and a second transporting unit 46. The first transporting unit 44 is disposed upstream from the second transfer roller 50, and transports the recording sheet P fed from the container 14 to the second transfer roller 50. The second transporting unit 46 is disposed downstream from the second transfer roller 50, and transports, to the fixing device 18, the recording sheet P that has the toner images second-transferred thereto while passing the second transfer position T2.

The first transporting unit 44 includes a driving roller 44A and a driven roller 44B spaced apart from each other in a transport direction of the recording sheet P, and a transport belt 45 wound around the driving roller 44A and the driven roller 44B. Similarly, the second transporting unit 46 includes a driving roller 46A and a driven roller 46B spaced apart from each other in the transport direction of the recording sheet P, and a transport belt 47 wound around the driving roller 46A and the driven roller 46B.

Fixing Device

The fixing device 18 includes a heating roller 48 serving as an example of a heating member, and a pressing roller 49 serving as an example of a pressing member. The fixing device 18 holds the recording sheet P with the heating roller 48 and the pressing roller 49 to heat and press the recording sheet P to fix the toner image transferred to the recording sheet P by the second transfer roller 50 to the recording sheet P.

Image Forming Operation

Subsequently, an outline of a basic image forming operation performed by the image forming apparatus 10 on the recording sheet P is described.

Various operations of the image forming apparatus 10 are performed by a controller installed in the apparatus. The controller is not illustrated. Upon receipt of an image forming instruction from the outside, the controller operates each toner image forming portion 20. The photoconductor drum 22 of each color is electrically charged by the charging device 24 while rotating. The controller transmits image data subjected to image processing to each exposure device 26. Each exposure device 26 irradiates the corresponding photoconductor drum 22 with exposure light in accordance with image data to expose the electrically charged photoconductor drum 22 to the light. Thus, an electrostatic latent image is formed on the outer circumferential surface 22A (also refer to FIG. 3) of each photoconductor drum 22. The electrostatic latent image formed on the outer circumferential surface 22A of each photoconductor drum 22 is developed by the corresponding developing device 28. Thus, a toner image of each color is formed on the outer circumferential surface 22A of the photoconductor drum 22 of the corresponding color.

The toner image of each color formed on the photoconductor drum 22 of the corresponding color is first-transferred to the intermediate transfer belt 42 by the first transfer roller 32 of the corresponding color at the corresponding first transfer position T1. At this time, the intermediate transfer belt 42 cycles. Thus, the toner images of the respective colors are sequentially first-transferred to the intermediate transfer belt 42 while being superposed on one another. The toner images superposed in this manner are transported to the second transfer position T2 with the cycle of the intermediate transfer belt 42. The superposed toner images are transferred to the recording sheet P from the intermediate transfer belt 42 at the second transfer position T2.

The recording sheet P to which the toner images are second-transferred is transported to the fixing device 18. The recording sheet P is heated and pressed by the fixing device 18 to have the toner images fixed thereto. The recording sheet P to which the toner images are fixed is discharged to a tray not illustrated.

Details of Developing Device

Subsequently, the developing device 28 according to the present exemplary embodiment is described in detail. As described above, in the present exemplary embodiment, the developing devices 28 for four colors of yellow (Y), magenta (M), cyan (C), and black (K) have the same structure, and thus are described without describing the color difference.

The side of the developing device 28 illustrated in FIG. 3 facing the photoconductor drum 22 in the X direction is defined as the front side (right side in the drawing), and the opposite side is defined as the rear side (left side in the drawing). A vertical direction described herein refers to “a vertical direction” in the drawings. As described above, the axial direction of the development roller 70 and the photoconductor drum 22 corresponds to the Y direction. The axial direction of the development roller 70 may be simply referred to as “the axial direction”. The direction toward the center in the axial direction of the development roller 70 is referred to as “an inner side in the axial direction”, “an axially inner side”, or “inward in the axial direction”, and the direction from the center toward the axial end portion is referred to as “an outer side in the axial direction”, “an axially outer side”, or “outward in the axial direction”. The direction from the axis of the development roller 70 toward a circumferential surface 70A is referred to as “an outer side in the radial direction”, “a radially outer side”, or “outward in the radial direction”. In addition, “the rotation direction” simply described refers to the rotation direction of the development roller 70 indicated with arrow K1.

Both sides in the axial direction of the front side portion of the developing device 28 opposing the photoconductor drum 22 have the same structure, except that they are mirror images of each other. Thus, one of the sides in the axial direction is simply illustrated and described.

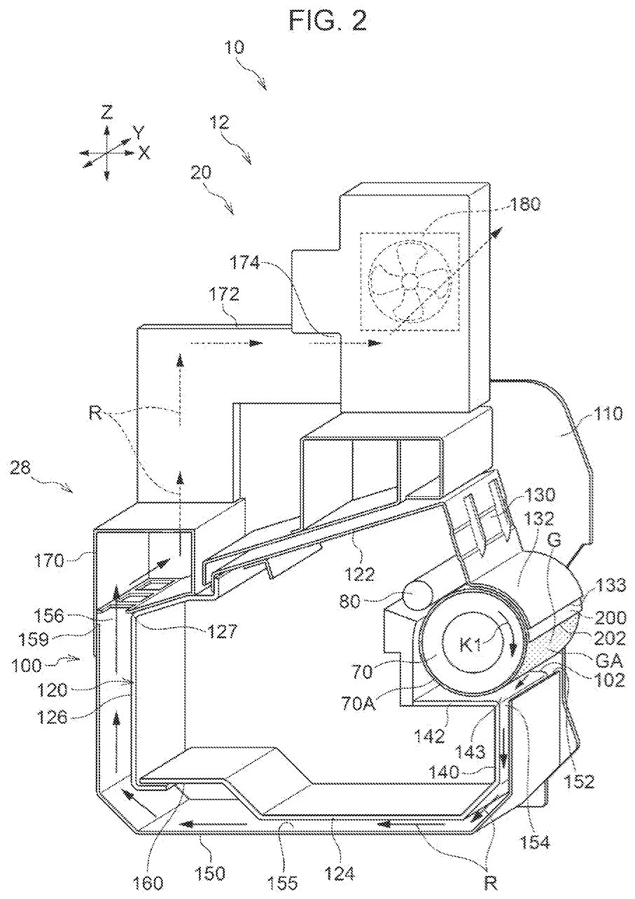

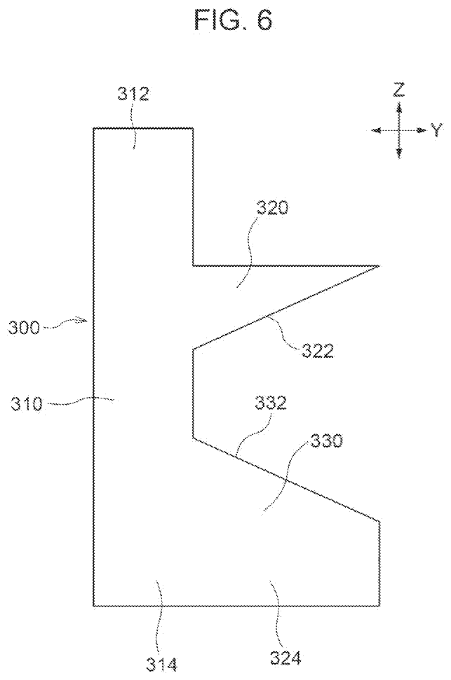

As illustrated in FIGS. 2 to 5, the developing device 28 includes the development roller 70 and seal members 300 (refer to FIG. 6). The developing device 28 includes a housing 100 in which the development roller 70 is rotatable.

The housing 100 accommodates a developer G inside, and has a rectangular opening 102 at the front side. The developer G inside the housing 100 is not illustrated. The development roller 70 is rotatably disposed in the housing 100 while being exposed through the opening 102. The housing 100 is disposed adjacent to the photoconductor drum 22 (refer to FIG. 3) in the X direction, and the opening 102 extends in the axial direction at a portion facing the photoconductor drum 22. In the housing 100, components not illustrated such as a supply auger and a steering auger that supply the developer G to the development roller 70 are disposed to extend in the axial direction.

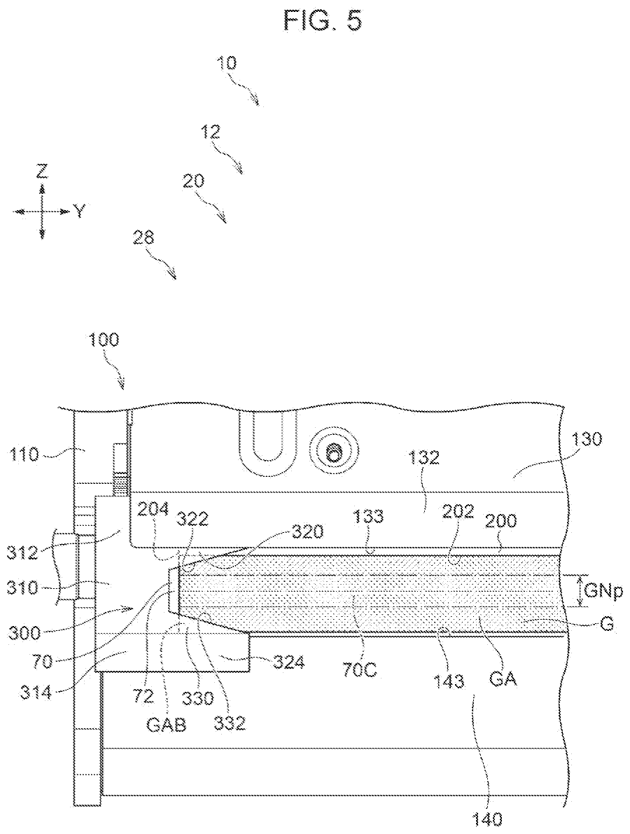

The development roller 70 holds the developer G on the circumferential surface 70A, and transports the developer G to a development nip GNp (refer to FIG. 5) described below. The developer G according to the present exemplary embodiment is a binary developer containing nonmagnetic toner and a magnetic carrier.

More specifically, as illustrated in FIG. 3, each development roller 70 is disposed to face the corresponding photoconductor drum 22, and develops the electrostatic latent image formed on the outer circumferential surface 22A of the photoconductor drum 22 with the developer G into a toner image or a visible image. Between the circumferential surface 70A of the development roller 70 and the outer circumferential surface 22A of the photoconductor drum 22, a gap, or a so-called development gap is formed.

As illustrated in FIGS. 2 to 5, the development roller 70 includes a magnet roller, not illustrated, inside. The magnet roller not illustrated has multiple magnetic poles that cause lines of magnetic force to magnetically attract the magnetic carrier of the developer G to the circumferential surface 70A of the development roller 70. The magnetic poles are disposed at preset angles. The development roller 70 rotates in the direction of arrow K1 with a rotational force transmitted from a driving source not illustrated.

As illustrated in FIG. 3, a thickness restriction member 80 (refer to FIG. 2) restricts the thickness of a developer layer GA formed from the developer G held on the circumferential surface 70A of the development roller 70. Although the thickness restriction member 80 according to the present exemplary embodiment has a pole shape, this is not the only possible example. For example, the thickness restriction member 80 may have a plate shape.

As illustrated in FIGS. 2 to 5, in the present exemplary embodiment, the developer layer GA comes into contact with the outer circumferential surface 22A (refer to FIG. 3) of the photoconductor drum 22 in an area of the circumferential surface 70A of the development roller 70 including a closest position 70C (refer to FIG. 5) closest to the outer circumferential surface 22A to form the development nip GNp (refer to FIG. 5). The latent image formed on the outer circumferential surface 22A of the photoconductor drum 22 at the development nip GNp is developed into a toner image.

As illustrated in FIG. 2, the housing 100 includes plate-shaped side surface portions 110 located on both sides in the axial direction and each having a plate thickness in the Y direction corresponding to the axial direction, and a plate-shaped circumferential surface portion 120 having a lying U shape having an opening facing the photoconductor drum 22 when viewed in the axial direction. The circumferential surface portion 120 has end portions in the axial direction joined to the side surface portions 110. The end portions, in the axial direction, of components such as the development roller 70, and a steering auger and a supply auger not illustrated are rotatably attached to the side surface portions 110. The end portions of the thickness restriction member 80 in the axial direction are fixed to the side surface portions 110.

The circumferential surface portion 120 of the housing 100 includes an upper surface portion 122, a lower surface portion 124, a rear vertical wall portion 126 disposed away from the photoconductor drum 22, and a front upper vertical wall portion 130 and a front lower vertical wall portion 140 facing the photoconductor drum 22.

The front upper vertical wall portion 130 is located in front of the thickness restriction member 80, and includes, at a lower portion, a curved portion 132 that is curved outward in the radial direction of the circumferential surface 70A of the development roller 70. The inner surface of the curved portion 132 is not in contact with the developer layer GA. The front lower vertical wall portion 140 has, at an upper portion, a flat portion 142 that is bent to extend rearward. The flat portion 142 is disposed below the development roller 70.

From another point of view, when a line segment connecting an axis 22V (refer to FIG. 3) of the photoconductor drum 22 and an axis 70V (refer to FIG. 3) of the development roller 70 is viewed from the photoconductor drum 22, the curved portion 132 of the front upper vertical wall portion 130 is located upstream in the rotation direction of the development roller 70, and the flat portion 142 of the front lower vertical wall portion 140 is located downstream in the rotation direction of the development roller 70. Hereafter, the case where a line segment connecting the axis 22V (refer to FIG. 3) of the photoconductor drum 22 and the axis 70V (refer to FIG. 3) of the development roller 70 is viewed from the photoconductor drum 22 is referred to as “a front view”.

The opening 102 is defined by a lower end portion 133 of the curved portion 132 of the front upper vertical wall portion 130, an upper end portion 143 of the flat portion 142 of the front lower vertical wall portion 140, and the side surface portions 110 on both sides in the axial direction.

The housing 100 according to the present exemplary embodiment also includes an outer flow path forming portion 150 on the outer side of the front lower vertical wall portion 140, the lower surface portion 124, and the rear vertical wall portion 126 of the circumferential surface portion 120. Outer end portions of the outer flow path forming portion 150 in the axial direction are joined to the side surface portions 110. Hereafter, the front lower vertical wall portion 140, the lower surface portion 124, and the rear vertical wall portion 126 of the circumferential surface portion 120 may be referred to as “an inner flow path forming portion 160”. The space defined by the side surface portions 110 on both sides in the axial direction, an inner flow path forming portion 160, and the outer flow path forming portion 150 serves as a flow path 155.

A front upper opening of the flow path 155 is defined as a suction opening 154, and a rear upper opening of the flow path 155 is defined as an exhaust opening 156. More specifically, the suction opening 154 is disposed between the upper end portion 143 of the flat portion 142 of the front lower vertical wall portion 140 and an upper end portion 152 at the front side of the outer flow path forming portion 150, opens upward, and has a rectangular shape having a length in the axial direction. The exhaust opening 156 is disposed between an upper end portion 127 of the rear vertical wall portion 126 and an upper end portion 159 at the rear side of the outer flow path forming portion 150, similarly opens upward, and has a rectangular shape having a length in the axial direction.

Above the exhaust opening 156, a box-shaped chamber 170 having a rectangular cross section taken perpendicularly to the axial direction is provided. A duct 172 is disposed on one side of the chamber 170 in the axial direction. A suction fan 180 is disposed at an end portion 174 of the duct 172. The suction fan 180 is driven by a power source not illustrated. The end portion 174 of the duct 172 is connected to the outlet port of the apparatus body not illustrated. A filter is disposed at the outlet port.

When the suction fan 180 is driven, air flows through the flow path 155 in the direction of arrows R. More specifically, air is sucked throughout the area of the suction opening 154 in the axial direction. Sucked air flows through the flow path 155 from the exhaust opening 156 to the chamber 170. Air that has flowed to the chamber 170 flows through the duct 172 from the first end portion in the axial direction, and is discharged out of the image forming apparatus 10 from the outlet port not illustrated. Fine powder such as toner in the air discharged out of the apparatus is trapped by the filter.

As illustrated in FIG. 5, the developer layer GA formed by the thickness restriction member 80 (refer to FIGS. 2 and 3) and held on the circumferential surface 70A of the development roller 70 is not formed on both sides in the axial direction. The areas of the development roller 70 where the developer layer GA is not formed are defined as axial end portions 72 of the development roller 70.

As described above, the portion of the developer layer GA facing the outer circumferential surface 22A of the photoconductor drum 22 comes into contact with the outer circumferential surface 22A to form the development nip GNp. The development nip GNp according to the present exemplary embodiment has a width of approximately 4 mm upstream and a width of approximately 4 mm downstream in the rotation direction of the closest position 70C where the photoconductor drum 22 and the development roller 70 are located closest to each other. However, this is not the only possible example.

In a front view, when the line segment connecting the axis 22V (refer to FIG. 3) of the photoconductor drum 22 and the axis 70V (refer to FIG. 3) of the development roller 70 is viewed from the photoconductor drum 22, the lower end portion 133 of the curved portion 132 of the front upper vertical wall portion 130 is located upstream from the development nip GNp in the rotation direction.

As illustrated in FIGS. 2 to 5, a rectangular film member 200 having a length in the axial direction is stuck on the back surface of the rear side of the curved portion 132. The film member 200 is an example of a third seal portion. The film member 200 extends downstream in the rotation direction beyond the lower end portion 133 of the curved portion 132, without extending to the development nip GNp (refer to FIG. 5). More specifically, when viewed from the front, a lower side portion 202 of the film member 200 located downstream in the rotation direction is located upstream in the rotation direction of the development nip GNp (refer to FIG. 5). Thus, the film member 200 is located outside of the developer layer GA in the radial direction, and covers, in the axial direction, the upstream portion of the development nip GNp (refer to FIG. 5) in the developer layer GA in the rotation direction. Side edge portions 204 of the film member 200 in the axial direction are located outside, in the axial direction, of end portions GAB (refer to FIG. 5) of the developer layer GA in the axial direction, and extend to the axial end portions 72 of the development roller 70. The film member 200 according to the present exemplary embodiment is formed from polyethylene terephthalate, and has a thickness of greater than or equal to 100 μm and smaller than or equal to 200 μm, but this is not the only possible example.

The seal members 300 are disposed on the radially outer side of the circumferential surface 70A on both sides of the development roller 70 in the axial direction. The seal members 300 according to the present exemplary embodiment are formed from thermoplastic polyurethane, and have a thickness of 100 μm to 200 μm, but they are not the only possible examples.

As illustrated in FIG. 2 to FIG. 6, each seal member 300 includes an end seal portion 310, an upstream seal portion 320, and a downstream seal portion 330. The end seal portion 310 is an example of a first seal portion, and the upstream seal portion 320 and the downstream seal portion 330 are examples of second seal portions.

The end seal portion 310 of each seal member 300 has a rectangular shape having a length in the rotation direction. The upstream seal portion 320 extends outward in the axial direction from the end seal portion 310, and has a triangular shape when viewed from the outside in the radial direction. The upstream seal portion 320 has a downstream side portion 322 located downstream in the upstream seal portion 320 in the rotation direction. The downstream side portion 322 is inclined upstream in the rotation direction as it extends inward in the axial direction from the outer side. The downstream seal portion 330 extends outward in the axial direction from a portion in the end seal portion 310 downstream from the upstream seal portion 320, and has a substantially triangular shape when viewed from the outside in the radial direction. More precisely, the downstream seal portion 330 has a triangular upstream portion and a rectangular downstream portion. The downstream seal portion 330 has an upstream side portion 332 located upstream in the downstream seal portion 330 in the rotation direction. The upstream side portion 332 is inclined downstream in the rotation direction as it extends inward in the axial direction from the outer side in the axial direction.

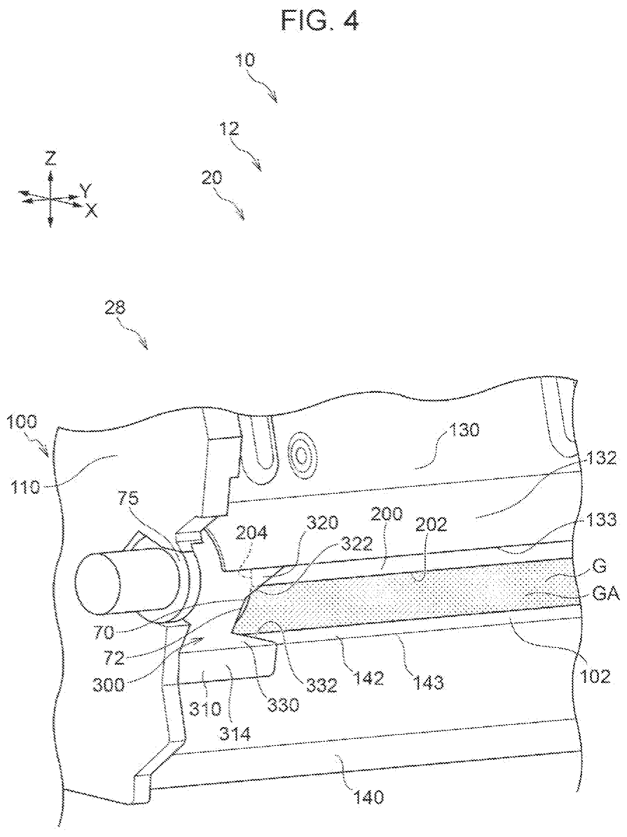

As illustrated in FIGS. 4 and 5, in each seal member 300, an upstream end portion 312 (refer to FIG. 6) of the end seal portion 310 is stuck on the back surface of the curved portion 132, and a downstream end portion 314 of the end seal portion 310 and a downstream end portion 324 (also refer to FIG. 6) of the downstream seal portion 330 are stuck on the outer side of an upper portion of the front lower vertical wall portion 140. The end seal portion 310 is located on the outer side of the film member 200 in the axial direction to cover the radially outer side of the axial end portion 72 of the development roller 70 where the developer layer GA is not formed. In the present exemplary embodiment, the end seal portion 310 of each seal member 300 is in contact with the axial end portion 72.

As illustrated in FIG. 5, the upstream seal portion 320 and the downstream seal portion 330 are disposed to cover the radially outer side of the axial end portion GAB of the developer layer GA and the circumferentially outer side of the development nip GNp. More specifically, when viewed from the front, the upstream seal portion 320 covers the end portion GAB of the developer layer GA upstream from the development nip GNp in the rotation direction, and the downstream seal portion 330 covers the end portion GAB of the developer layer GA downstream in the rotation direction.

When viewed from the front, the upstream seal portion 320 overlaps the radially outer side of an axial end portion 210 of the film member 200. The upstream seal portion 320 covers the portion of the end portion GAB of the developer layer GA located downstream in the rotation direction from the downstream lower side portion 202 of the film member 200.

The end portions GAB of the developer layer GA according to the present exemplary embodiment on both sides in the axial direction are on the outer side, in the axial direction, of an exposure area of the outer circumferential surface 22A of the photoconductor drum 22 that the exposure device 26 exposes to light, but these are not the only possible examples. For example, the end portions GAB may be on the inner side in the axial direction.

In the present exemplary embodiment, the upstream seal portion 320 and the downstream seal portion 330 are disposed not to touch the developer layer GA, but may touch the developer layer GA. However, the downstream seal portion 330 is preferably disposed not to touch the developer layer GA.

In a front view, a line CL indicates a cleaning area CL for the cleaning blade 60 that cleans the outer circumferential surface 22A of the photoconductor drum 22. In the present exemplary embodiment, the cleaning area CL corresponds to the area of the outer circumferential surface 22A of the photoconductor drum 22 that the far end portion 62 of the cleaning blade 60 touches. The upstream seal portion 320 and the downstream seal portion 330 extend inward in the axial direction beyond an outer end portion CLA of the cleaning area CL in the axial direction.

Operations

Subsequently, operations according to the present exemplary embodiment are described.

Each seal member 300 of the developing device 28 according to the present exemplary embodiment includes the upstream seal portion 320 and the downstream seal portion 330 that cover the axial end portion GAB of the developer layer GA. This structure reduces toner scatter from the axial end portions GAB of the developer layer GA compared to a structure simply including the end seal portions 310 that covers the axial end portions 72 of the development roller 70 where the developer layer GA is not formed.

In the present exemplary embodiment, the suction opening 154 is formed below the development roller 70 to extend in the axial direction. Regardless of when toner scatters from the developer layer GA on the development roller 70, the toner is sucked and trapped from the suction opening 154.

However, the suction opening 154 is more likely to have a weaker suction force at both axial end portions than at an axial center portion. One reason why the suction opening 154 has a weaker suction force at both end portions is turbulence caused by the side surface portions 110 at both ends of the suction opening 154 in the axial direction. As in the present exemplary embodiment, when the duct 172 accommodating the suction fan 180 is connected to a first side in the axial direction of the chamber 170 continuous with the exhaust opening 156 of the flow path 155, the suction opening 154 is more likely to have a weaker suction force at the end portion on a second side than on the first side. Although different from the structure of the present exemplary embodiment, when the duct 172 is connected to an axial center portion of the chamber 170, the suction opening 154 is more likely to have a weaker suction force at both end portions than at an axial center portion.

For such a reason, the suction opening 154 is more likely to have a weaker suction force at both axial end portions than at an axial center portion, and less easily traps scattered toner. Airborne toner left without being trapped may leak out of the developing device 28 to stain inside the image forming apparatus 10.

However, in the present exemplary embodiment, as described above, each upstream seal portion 320 and each downstream seal portion 330 cover the corresponding axial end portion GAB of the developer layer GA, and thus reduce toner scatter from the end portion GAB of the developer layer GA. Thus, despite when the suction opening 154 has a weaker suction force at both axial end portions, airborne toner left without being trapped is reduced.

The upstream seal portion 320 and the downstream seal portion 330 of the seal member 300 cover the circumferentially outer side of the development nip GNp of the developer layer GA. Thus, the upstream seal portion 320 and the downstream seal portion 330 are less likely to get caught than in the case where the upstream seal portion 320 and the downstream seal portion 330 cover the development nip GNp.

More specifically, the upstream seal portion 320 covers the upstream portion of the development nip GNp. Thus, the upstream seal portion 320 is less likely to get caught than in the case where the upstream seal portion 320 covers the development nip GNp.

Similarly, the downstream seal portion 330 cover the downstream portion of the development nip GNp. Thus, the downstream seal portion 330 is less likely to get caught than in the case where the downstream seal portion 330 covers the development nip GNp.

The downstream side portion 322 of the upstream seal portion 320 is inclined upstream in the rotation direction as it extends inward in the axial direction from the outer side. Thus, the upstream seal portion 320 is less likely to get caught than when the downstream side portion 322 extends in the axial direction.

The upstream side portion 332 of the downstream seal portion 330 is inclined downstream in the rotation direction as it extends inward in the axial direction from the outer side. Thus, the downstream seal portion 330 is less likely to get caught than when the upstream side portion 332 extends in the axial direction.

The upstream seal portion 320 overlaps the radially outer side of the axial end portion 210 of the film member 200. Thus, despite when toner scatters outward from the end portion 210 of the film member 200, the upstream seal portion 320 located above further reduces the scattering than when the upstream seal portion 320 overlaps the radially inner side of the axial end portion 210 of the film member 200.

Despite when airborne toner left without being sucked from the suction opening 154 adheres to the outer circumferential surface 22A of the photoconductor drum 22, the toner is removed as long as it is within the cleaning area CL of the cleaning blade 60, but fails to be removed when it is out of the cleaning area CL. In the present exemplary embodiment, however, the upstream seal portion 320 and the downstream seal portion 330 extend inward in the axial direction beyond the outer end portion CLA of the cleaning area CL in the axial direction. This structure thus further reduces scatter of toner left without being removed by the cleaning blade 60 than when the upstream seal portion 320 and the downstream seal portion 330 are located outside of the outer end portion CLA in the axial direction.

In the image forming apparatus 10, each seal member 300 of the developing device 28 includes the upstream seal portion 320 and the downstream seal portion 330 that cover the corresponding axial end portion GAB of the developer layer GA. This structure thus further reduces airborne toner left in the image forming apparatus 10 than a structure that simply includes the end seal portions 310 that cover the axial end portions 72 of the development roller 70 where the developer layer GA is not formed.

Others

The present disclosure is not limited to the above exemplary embodiments.

For example, in the exemplary embodiment, the suction fan 180 is driven to flow air through the flow path 155. However, this is not the only possible example. A cooling fan that cools, for example, the fixing device 18 may be used to flow air through the flow path 155. Alternatively, scattered toner may be trapped with airflow resulting from rotations of the photoconductor drum 22 and the development roller 70.

For example, in the above exemplary embodiment, the upstream seal portions 320 and the downstream seal portions 330 are disposed outside of the development nip GNp in the circumferential direction, without extending to the development nip GNp. However, either the upstream seal portions 320 or the downstream seal portions 330 or both may extend to the development nip GNp.

For example, in the exemplary embodiment, each seal member 300 includes the upstream seal portion 320 and the downstream seal portion 330, but this is not the only possible example. Each seal member 300 may include only one of the upstream seal portion 320 and the downstream seal portion 330. Nevertheless, each seal member 300 preferably includes the downstream seal portion 330 as the downstream seal portion 330 has a greater effect on reduction of toner scatter.

For example, in the exemplary embodiment, the downstream side portion 322 of each upstream seal portion 320 is inclined upstream in the rotation direction as it extends inward in the axial direction from the outer side, but this is not the only possible example. For example, the side portion 322 may extend in the axial direction. Similarly, the upstream side portion 332 of each downstream seal portion 330 is inclined downstream in the rotation direction as it extends inward in the axial direction from the outer side, but this is not the only possible example. For example, the upstream side portion 332 may extend in the axial direction.

The present disclosure may be embodied in various aspects within the range not departing from the gist of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A developing device comprising:
a development roller that has a circumferential surface on which a developer layer is formed at a portion facing an image carrier;
a first seal portion that covers an outer side, in a radial direction, of an axial end portion of the development roller where the developer layer is not formed at the portion facing the image carrier; and
a second seal portion that extends inward in an axial direction from the first seal portion, and that covers an outer side, in the radial direction, of an axial end portion of the developer layer.
   (((2)))

The developing device according to (((1))),
wherein the second seal portion covers an outer side, in a circumferential direction, of a development nip of the developer layer formed together with the image carrier.
   (((3)))

The developing device according to (((2))),
wherein the second seal portion covers the developer layer at a portion upstream from the development nip in a rotation direction of the development roller.
   (((4)))

The developing device according to (((3))),
wherein a side portion of the second seal portion located downstream in the rotation direction is inclined upstream in the rotation direction as the side portion extends inward in the axial direction from an outer side in the axial direction.
   (((5)))

The developing device according to (((3))) or (((4))), comprising:
a third seal portion that extends in the axial direction to cover the developer layer at a portion upstream from the development nip in the rotation direction,
wherein the second seal portion overlaps an outer side, in a radial direction, of an end portion of the third seal portion in the axial direction.
   (((6)))

The developing device according to any one of (((2))) to (((5))),
wherein the first seal portion covers the developer layer at a portion downstream from the development nip in a rotation direction of the development roller.
   (((7)))

The developing device according to (((6))),
wherein a side portion of the second seal portion located upstream in the rotation direction is inclined downstream in the rotation direction as the side portion extends inward in the axial direction from an outer side in the axial direction.
   (((8)))

The developing device according to any one of (((1))) to (((7))),
wherein the second seal portion extends inward in the axial direction beyond an outer end portion, in the axial direction, of a cleaning area of a cleaning member that cleans an outer circumferential surface of the image carrier.
   (((9)))

An image forming apparatus, comprising:
the developing device according to any one of (((1))) to (((8)));
an image carrier that has a toner image formed by the developing device;
a transfer unit that transfers the toner image formed on the image carrier to a recording medium; and
a fixing device that fixes the toner image transferred to the recording medium onto the recording medium.

What is claimed is:

1. A developing device comprising:
a development roller that has a circumferential surface on which a developer layer is formed at a portion facing an image carrier;
a first seal portion that covers an outer side, in a radial direction, of an axial end portion of the development roller where the developer layer is not formed at the portion facing the image carrier; and
a second seal portion that extends inward in an axial direction from the first seal portion, and that covers an outer side, in the radial direction, of an axial end portion of the developer layer.

2. The developing device according to claim 1,
wherein the second seal portion covers an outer side, in a circumferential direction, of a development nip formed by the developer layer and the image carrier.

3. The developing device according to claim 2,
wherein the second seal portion covers the developer layer at a portion upstream from the development nip in a rotation direction of the development roller.

4. The developing device according to claim 3,
wherein a side portion of the second seal portion located downstream in the rotation direction is inclined upstream in the rotation direction as the side portion extends inward in the axial direction from an outer side in the axial direction.

5. The developing device according to claim 3, comprising:
a third seal portion that extends in the axial direction to cover the developer layer at a portion upstream from the development nip in the rotation direction,
wherein the second seal portion overlaps an outer side, in a radial direction, of an end portion of the third seal portion in the axial direction.

6. The developing device according to claim 2,
wherein the first seal portion covers the developer layer at a portion downstream from the development nip in a rotation direction of the development roller.

7. The developing device according to claim 6,
wherein a side portion of the second seal portion located upstream in the rotation direction is inclined downstream in the rotation direction as the side portion extends inward in the axial direction from an outer side in the axial direction.

8. The developing device according to claim 1,
wherein the second seal portion extends inward in the axial direction beyond an outer end portion, in the axial direction, of a cleaning area of a cleaning member that cleans an outer circumferential surface of the image carrier.

9. An image forming apparatus, comprising:
the developing device according to claim 1;
an image carrier that has a toner image formed by the developing device;
a transfer unit that transfers the toner image formed on the image carrier to a recording medium; and
a fixing device that fixes the toner image transferred to the recording medium onto the recording medium.

10. An image forming apparatus, comprising:
the developing device according to claim 2;
an image carrier that has a toner image formed by the developing device;
a transfer unit that transfers the toner image formed on the image carrier to a recording medium; and
a fixing device that fixes the toner image transferred to the recording medium onto the recording medium.

11. An image forming apparatus, comprising:
the developing device according to claim 3;
an image carrier that has a toner image formed by the developing device;
a transfer unit that transfers the toner image formed on the image carrier to a recording medium; and
a fixing device that fixes the toner image transferred to the recording medium onto the recording medium.

12. An image forming apparatus, comprising:
the developing device according to claim 4;
an image carrier that has a toner image formed by the developing device;
a transfer unit that transfers the toner image formed on the image carrier to a recording medium; and
a fixing device that fixes the toner image transferred to the recording medium onto the recording medium.

13. An image forming apparatus, comprising:
the developing device according to claim 5;
an image carrier that has a toner image formed by the developing device;
a transfer unit that transfers the toner image formed on the image carrier to a recording medium; and
a fixing device that fixes the toner image transferred to the recording medium onto the recording medium.

14. An image forming apparatus, comprising:
the developing device according to claim 6;
an image carrier that has a toner image formed by the developing device;
a transfer unit that transfers the toner image formed on the image carrier to a recording medium; and
a fixing device that fixes the toner image transferred to the recording medium onto the recording medium.

15. An image forming apparatus, comprising:
the developing device according to claim 7;
an image carrier that has a toner image formed by the developing device;
a transfer unit that transfers the toner image formed on the image carrier to a recording medium; and
a fixing device that fixes the toner image transferred to the recording medium onto the recording medium.

16. An image forming apparatus, comprising:
the developing device according to claim 8;
an image carrier that has a toner image formed by the developing device;
a transfer unit that transfers the toner image formed on the image carrier to a recording medium; and
a fixing device that fixes the toner image transferred to the recording medium onto the recording medium.
